(19) United States
(12) Patent Application Publication
(10) Pub. No.: US 2009/0232039 A1
(43) Pub. Date: Sep. 17, 2009

(54) PORTABLE TERMINAL AND MODE CONTROL METHOD FOR THE SAME

(75) Inventor: Yong Jae JUNG, Seoul (KR)

Correspondence Address: Jefferson IP Law, LLP, 1730 M Street, NW, Suite 807, Washington, DC, 20036, US

(73) Assignee: SAMSUNG ELECTRONICS CO. LTD., Suwon-si (KR)

(21) Appl. No.: 12/404,587

(22) Filed: Mar. 16, 2009

(30) Foreign Application Priority Data
Mar. 14, 2008 (KR) 10-2008-0023726

(51) Int. Cl. H04W 52/02

(52) U.S. Cl. 370/311

(57) ABSTRACT

A portable terminal capable of Internet access and a mode control method for the same are provided. The mode control method includes analyzing, upon reception of a packet during a sleep mode, the received packet, determining whether the received packet corresponds to service setting information, and transitioning, when the received packet corresponds to the service setting information, into an awake mode. The service setting information may include a list of IP-based services classified by protocol.

### PRIORITY

This application claims the benefit under 35 U.S.C. § 119(a) of a Korean patent application filed in the Korean Intellectual Property Office on Mar. 14, 2008 and assigned Serial No. 10-2008-0023726, the entire disclosure of which is hereby incorporated by reference.

### BACKGROUND OF THE INVENTION

1. Field of the Invention

The present invention relates to a portable terminal supporting Internet Protocol (IP)-based services. More particularly, the present invention relates to a portable terminal that adaptably controls an operation mode according to types of received packets in relation to IP-based services, and to a mode control method for the same.

2. Description of the Related Art

With recent advances in wireless technologies, wireless networks have been replacing wired networks. In contrast to wired networks, wireless networks do not have mobility limitations. Accordingly, various technologies utilizing wireless networks are being actively developed. In particular, portable Internet service technologies have attracted much attention.

Portable Internet services enable high-speed data transmission to mobile users through wireless IP networks. Thereby, the mobile users may send and receive data, and receive various Internet services.

Portable Internet services are based on Internet Protocol (IP), and include services related to Hyper Text Transfer Protocol (HTTP), File Transfer Protocol (FTP), Packet Internet Groper (PING), and Voice over Internet Protocol (VoIP).

When a portable terminal is connected to an IP network for a portable Internet service, if no operation is performed for a preset duration, the portable terminal transitions into a sleep mode for saving power. In response to an internal or external event during the sleep mode, the portable terminal transitions into the awake mode and performs an operation requested by the event. The event may correspond to an input of a key signal that is input for manipulation of the portable terminal or to reception of a packet from the IP network.

That is, when the portable terminal receives a packet from the IP network during the sleep mode, the portable terminal transitions from the sleep mode into an awake mode, performs a corresponding operation, and notifies the user of packet reception. The notification of packet reception to the user may be carried out in various ways, such as displaying information on a display unit, producing sounds through an audio unit, and producing vibrations through a vibration output unit.

However, the portable terminal may frequently receive unsolicited packets, in addition to desired packets, from the IP network. For example, the portable terminal may receive packets sent by many unspecified Web servers in relation to Web services, or receive packets periodically sent by a particular program server in relation to checking the state of clients.

Reception of unsolicited packets causes the portable terminal to leave the sleep mode. Whenever an unsolicited packet is received, the portable terminal transitions into the awake mode, which increases power consumption. Herein, the user is inconvenienced by having to perform an operation for handling notification of packet reception.

In other words, although the portable terminal transitions into the sleep mode for saving power, unsolicited packets from the IP network cause the portable terminal to frequently leave the sleep mode, leading to an unnecessary increase in power consumption. In addition, unexpected operations of the portable terminal due to unsolicited packets may inconvenience the user.

### SUMMARY OF THE INVENTION

An aspect of the present invention is to address at least the above-mentioned problems and/or disadvantages and to provide at least the advantages described below. Accordingly, an aspect of the present invention is to provide a portable terminal and mode control method for the same wherein the operation mode is controlled according to a service being received.

Another aspect of the present invention is to provide a portable terminal and mode control method for the same wherein the operation mode is controlled according to the protocol associated with a packet received from an IP network.

Yet another aspect of the present invention is to provide a portable terminal and mode control method for the same wherein operations due to unsolicited packets are controlled according to setting information.

Still another aspect of the present invention is to provide a portable terminal and mode control method for the same wherein the sleep mode is maintained depending upon a received service for reducing power consumption.

In accordance with an aspect of the present invention, a mode control method for a portable terminal is provided. The method includes analyzing, upon reception of a packet during a sleep mode, the received packet, determining whether the received packet corresponds to service setting information, and transitioning, when the received packet corresponds to the service setting information, into an awake mode.

In accordance with another aspect of the present invention, a mode control method for a portable terminal capable of Internet access is provided. The method includes analyzing, when an event related to reception of a packet occurs during a sleep mode, the received packet after transitioning into a suspend mode, determining whether the received packet corresponds to service setting information by comparing information on the received packet with the service setting information, transitioning, when the received packet corresponds to the service setting information, from the suspend mode into an awake mode, and transitioning, when the received packet does not correspond to the service setting information, from the suspend mode into the sleep mode.

In accordance with yet another aspect of the present invention, a portable terminal capable of Internet access is provided. The terminal includes a communication module for establishing a communication channel to a server through an IP network in a preset manner, and for performing communication for IP-based services, a storage unit for storing one or more applications used for functions related to the terminal, data generated from execution of the applications, and setting information, and a control unit for controlling a state of the terminal according to a protocol of a received packet in relation to an IP-based service.

According to an aspect of the present invention, using a mode control method, a portable terminal connected to an IP network may control mode transitions caused by reception of packets according to types of the packets. That is, in relation to unsolicited packets, the portable terminal remains in the sleep mode. Hence, unnecessary mode transitions to an awake mode are reduced, thereby reducing power consumption. In addition, unexpected operations of the portable terminal due to unsolicited packets may be reduced, thereby increasing user convenience.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following detailed description taken in conjunction with the accompanying drawings, in which:

FIG. 1 illustrates a communication environment involving a portable terminal and IP network according to an exemplary embodiment of the present invention;

FIG. 2 is a block diagram of a portable terminal according to an exemplary embodiment of the present invention;

FIG. 3 illustrates packet processing in a portable terminal according to an exemplary embodiment of the present invention; and

FIG. 4 is a flowchart illustrating a mode control method for a portable terminal according to an exemplary embodiment of the present invention.

Throughout the drawings, it should be noted that like reference numbers are used to depict the same or similar elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Exemplary embodiments of the present invention relate to a portable terminal and the portable terminal's mode control depending upon received packets. In particular, the state of the portable terminal connected to an IP network is controlled according to types of the received packets.

That is, during reception of an IP-based service, the portable terminal controls mode transitions according to the types of the received packets. Upon reception of IP-based service packets, the portable terminal remains in the sleep mode or transitions to the awake mode based on packet types and setting information, thereby reducing battery power consumption due to unnecessary operations and enhancing user convenience.

The portable terminal includes a communication module for Internet access, and may connect to an IP network through the communication module. After establishing a connection to the IP network, the portable terminal may send and receive various service-related packets. This communication is described below.

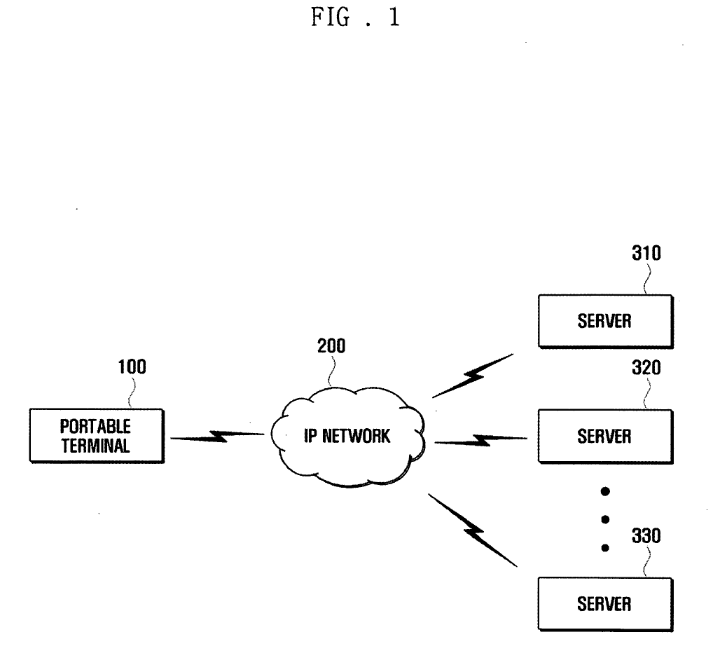

FIG. 1 illustrates a communication environment involving a portable terminal and IP network according to an exemplary embodiment of the present invention.

Referring to FIG. 1, the portable terminal 100 supports Internet access, and can send and receive service-related packets through an IP network 200 to and from various servers 310 to 330. That is, the portable terminal 100 sends a request for a service selected by a user through the IP network 200 to a corresponding one of the servers 310 to 330, and receives a response related to the request from the corresponding server.

The portable terminal 100 can receive IP-based services through wired and wireless networks. As described herein, the portable terminal 100 is assumed to receive a portable Internet service through a wireless network. Therefore, the portable terminal 100 may include a communication module for portable Internet services.

The portable terminal 100 may be any information and communication appliance supporting Internet services through a communication module, such as a Personal Digital Assistant (PDA), MP3 player, personal computer, smart phone, mobile phone, and the like.

The IP network 200 is a communication network connecting the portable terminal 100 and the servers 310 to 330 together for information exchange. In response to a user request, the portable terminal 100 capable of Internet access may readily connect though the IP network 200 to a desired server to send and receive packets. The IP network 200 may be a wired network or wireless network. As described herein, the IP network 200 is assumed to be a wireless network.

The servers 310 to 330 may send and receive packets through the IP network 200 to and from the portable terminal 100. The servers 310 to 330 may include a server that provides a service requested by the portable terminal 100, a server that periodically provides a service according to information set by the portable terminal 100, a server that sends arbitrary advertisements to the portable terminal 100, and a server that provides a service like a VoIP service through the IP network 200.

The portable terminal 100 may transition into the sleep mode to save power when the user leaves the portable terminal 100 idle for a preset time duration or actuates a sleep mode function key.

In the sleep mode, the portable terminal 100 suspends execution and operation of most programs and components like a display unit to thereby reduce power consumption. At the end of the sleep mode, the portable terminal 100 may recover the previous state. During the sleep mode, the portable terminal 100 remains in an inactive state until a particular event occurs, and the communication module for Internet access may await arrival of a packet.

That is, after transitioning into the sleep mode, the portable terminal 100 remains in the sleep mode until an event requested by the user or set in advance occurs. The event may be an event like an alarm that is set in advance by the user and then automatically executed.

Upon reception of a packet from the IP network 200 during the idle mode, the portable terminal 100 transitions from the idle mode into the awake mode and may perform a requested operation. For example, when a packet related to a VoIP service is received, the portable terminal 100 processes the packet in the awake mode.

When the communication module receives a packet from the IP network 200, it notifies the control unit of packet reception, and then the control unit switches the operation mode from the sleep mode into the awake mode.

However, the portable terminal 100 does not always receive packets that are desired or expected by the user. That is, the portable terminal 100 may frequently receive unsolicited packets from servers or other portable terminals.

If the portable terminal 100 transitions into the awake mode whenever a packet is received, an unsolicited packet also causes the portable terminal 100 to perform a mode transition for handling the unsolicited packet. Hence, in response to reception of an unsolicited packet, the user may have to manipulate the portable terminal 100, which adds inconvenience to the user. In addition, the activation of the portable terminal 100 results in unnecessary power consumption.

In an exemplary embodiment, the portable terminal 100 stores a list of IP-based services to receive made by the user for further processing of packets. For example, the list may include services related to at least one of Hyper Text Transfer Protocol (HTTP), File Transfer Protocol (FTP), Packet Internet Groper (PING), Voice over Internet Protocol (VoIP), and the like.

Accordingly, when a packet is received from the IP network 200 during the sleep mode, the portable terminal 100 transitions from the sleep mode into the suspend mode. In the suspend mode, the operating system of the portable terminal 100 is active to process a received packet, but other components such as a display unit are inactive and the user is not aware of a mode or state transition.

In the suspend mode, the portable terminal 100 analyzes the received packet, and determines whether the received packet is related to the list of IP-based services to receive. This analysis and comparison may be performed by a control unit and an operating system.

If the received packet is related to the list of IP-based services to receive, the portable terminal 100 transitions from the suspend mode into the awake mode and performs an operation requested by the packet. If the received packet is not related to the list of IP-based services to receive, the portable terminal 100 may transition from the suspend mode into the sleep mode without further processing of the packet.

In the description above, a list of IP-based services to receive is created by the user, a manufacturer, a service provider, or the like. Alternatively, the list of IP-based services may be a list of IP-based services not to receive.

In an exemplary embodiment of the present invention, the list of allowed or disallowed IP-based services may be created. By using the list of allowed or disallowed IP-based services, the user may not have to be inconvenienced by unsolicited packets, and the power consumption of the portable terminal 100 may be reduced. Hereafter, it is assumed that the list of IP-based services is a list of IP-based services to receive.

Next, an exemplary embodiment of the present invention is described in more detail.

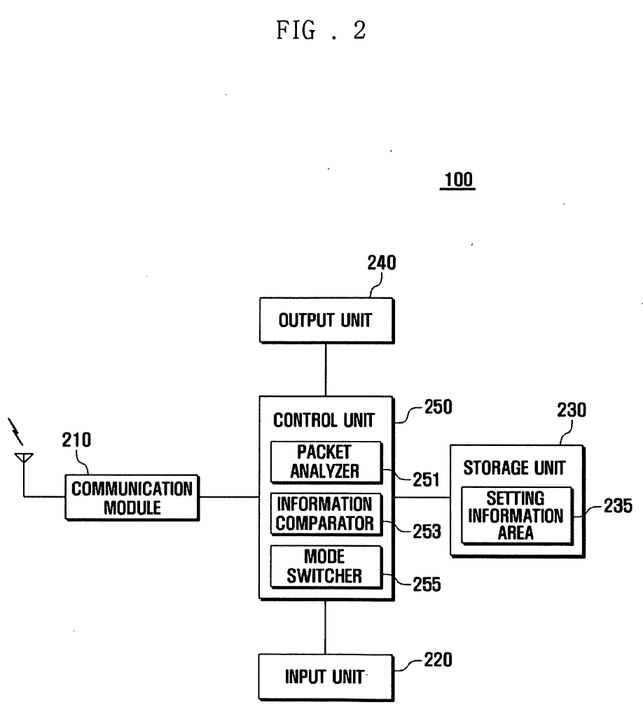

FIG. 2 is a block diagram of a portable terminal according to an exemplary embodiment of the present invention.

Referring to FIG. 2, the portable terminal 100 includes a communication module 210, input unit 220, storage unit 230, output unit 240, and control unit 250.

The communication module 210 performs communication operations for the portable terminal 100. The communication module 210 establishes a communication channel to a server or another portable terminal in a preset manner, and performs data and voice communication (e.g. VoIP). That is, the communication module 210 establishes a communication channel to a server through an IP network in a preset manner, and performs communication for IP-based services.

The communication module 210 may send and receive packets related to an IP-based service through a wireless IP network. The communication module 210 may be included in the portable terminal 100 as illustrated in FIG. 2. The communication module 210 may also be configured as a separate entity independent of the portable terminal 100, and may be connected through a preset interface to the portable terminal 100 for IP-based services.

The input unit 220 generates a key signal related to input of alphanumeric information, setting of functions, and manipulation of the portable terminal 100, and sends the key signal to the control unit 250. The input unit 220 may include one of a touch pad, touch screen, conventional keypad, QWERTY keypad and function keys for special functions, or a combination thereof.

The storage unit 230 stores applications necessary for functions related to exemplary embodiments of the present invention, data generated from execution of the applications, and data generated by the user. The storage unit 230 may include one or more buffers to temporarily store data generated from execution of the applications.

The storage unit 230 may include a setting information area 235 to store setting information provided by the user. The setting information may include a list of IP-based services to receive, a list of IP-based services not to receive, and function settings.

The setting information may be classified by protocols such as HTTP, FTP, PING, VoIP, and the like. The user may select IP-based services based on at least one of HTTP, FTP, PING, VoIP, and the like for reception.

The applications related to exemplary embodiments of the present invention may include an application that determines the type of a packet received during the sleep mode, compares the packet type with the setting information, and changes the mode of the portable terminal 100 according to the comparison result.

The output unit 240 includes modules related to the output of the portable terminal 100. The output unit 240 may include a display section to display screen data, and an audio section to process audio signals.

The control unit 250 controls the overall operation of the portable terminal 100 and signal exchange between the components thereof. That is, the control unit 250 signal controls exchanges between the communication module 210, input unit 220, storage unit 230, and output unit 240. The control unit 250 may include a data processing section having a codec and modem for mobile communication services.

In particular, the control unit 250 controls the mode of the portable terminal 100 according to the type of a received packet in relation to a list of IP-based services to receive. That is, when a packet is received through the communication module 210 during the sleep mode, the control unit 250 controls a mode transition from the sleep mode into the suspend mode. Then, the control unit 250 analyzes the received packet in the suspend mode, and determines whether the received packet is related to the list of IP-based services to receive.

If the received packet is related to the list of IP-based services to receive, the control unit 250 controls a transition from the suspend mode into the awake mode. Thereafter, the control unit 250 performs an operation requested by the received packet and notifies the user of packet reception. If the received packet is not related to the list of IP-based services to receive, the control unit 250 controls a transition from the suspend mode into the idle mode.

To achieve the transition, the control unit 250 may include a packet analyzer 251 to determine the type of a packet received in the sleep mode, an information comparator 253 to compare the packet type from the packet analyzer 251 with the setting information, and a mode switcher 255 to perform mode switching according to the comparison result.

The packet analyzer 251 may check the header of a received packet to identify the IP-based protocol related to the packet. That is, IP-based services are distinguished by protocols such as HTTP, FTP, PING, VoIP and the like. To be more specific, if the header indicates HTTP, the packet is related to a Web service. If the header indicates the User Datagram Protocol (UDP) or the Transmission Control Protocol (TCP), the packet is related to an FTP service. If the header indicates the Internet Control Message Protocol (ICMP), the packet is related to a PING service. If the header indicates the Session Initiation Protocol (SIP), the packet is related to a VoIP service.

The information comparator 253 may compare the IP-based protocol identified by the packet analyzer 251 with the list of IP-based services to receive. For example, when the user selects HTTP and VoIP services through a user interface in advance, the information comparator 253 may determine whether the IP-based protocol related to a received packet corresponds to one of the selected HTTP and VoIP services.

Then, if the IP-based protocol related to the received packet corresponds to one of the selected HTTP and VoIP services, the mode switcher 255 may cause the transition into the awake mode. If the IP-based protocol related to the received packet does not correspond to one of the selected HTTP and VoIP services, the mode switcher 255 causes the transition into the sleep mode.

The packet analyzer 251, information comparator 253, and mode switcher 255 may be integrated in a service management unit (not shown), and the service management unit may be implemented on a driver (not shown) that manages the communication module 210 at the interface between the communication module 210 and control unit 250. The service management unit may also be implemented as application software.

In addition, when a received packet is not related to the list of IP-based services to receive, the control unit 250 may discard the received packet or store the received packet in the storage unit 230 for later processing. At this time, the control unit 250 handles the received packet in the suspend mode, and does not notify the user of packet reception. That is, the output unit 240 and the like remain in an inactivated state.

As described above, after the user creates a list of IP-based services to receive, the operation mode is switched to the awake mode when a received packet is related to the list. Accordingly, the user may not have to be inconvenienced by unsolicited packets, and the power consumption of the portable terminal may be reduced.

The portable terminal 100 in FIG. 2 only includes elements used for the description of an exemplary embodiment of the present invention. However, the present invention is not limited thereto. The portable terminal 100 may further include at least one of a camera module, electronic payment module, digital broadcast receiving module, mobile communication module, and the like. In the portable terminal 100, one of the elements may be removed or replaced with another element and one or more of the elements may be separated or combined.

Hereinabove, the configuration and operation of the portable terminal 100 are described. Next, mode control of the portable terminal 100 according to an exemplary embodiment of the present invention is described. However, the present invention is not limited to the following description.

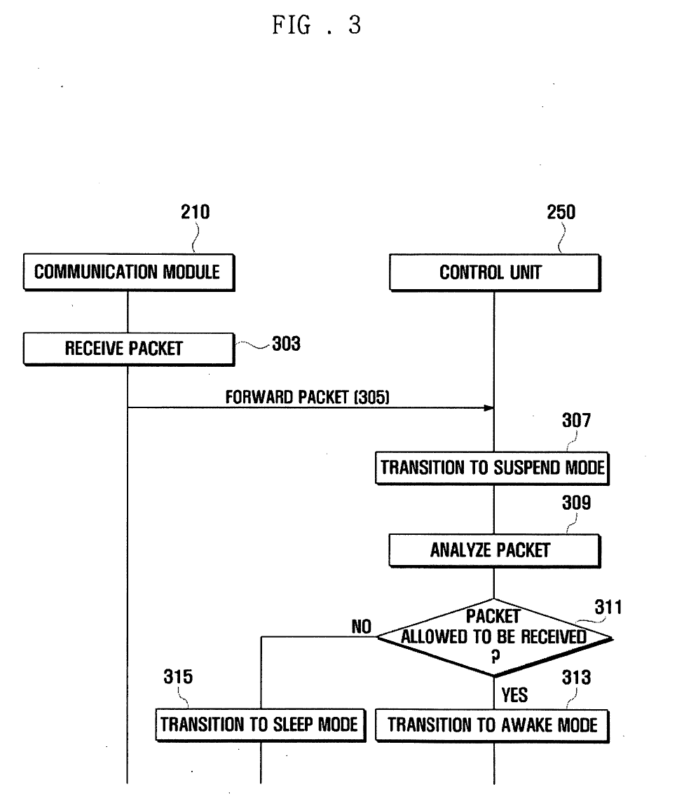

FIG. 3 illustrates packet processing in a portable terminal according to an exemplary embodiment of the present invention.

Referring to FIG. 3, when a packet is received during the sleep mode in step 303, the communication module 210 of the portable terminal 100 forwards the received packet to the control unit 250 in step 305.

Upon reception of the packet, the control unit 250 controls a transition from the sleep mode into the suspend mode in step 307. The control unit 250 analyzes the received packet in step 309. Packet analysis is described above with reference to FIG. 2.

The control unit 250 determines whether the received packet is related to the list of IP-based services to receive based on the result of the packet analysis in step 311.

If the received packet is related to the list of IP-based services to receive, the control unit 250 controls a transition from the suspend mode into the awake mode in step 313. If the received packet is not related to the list of IP-based services to receive, the control unit 250 controls a transition from the suspend mode into the sleep mode in step 315.

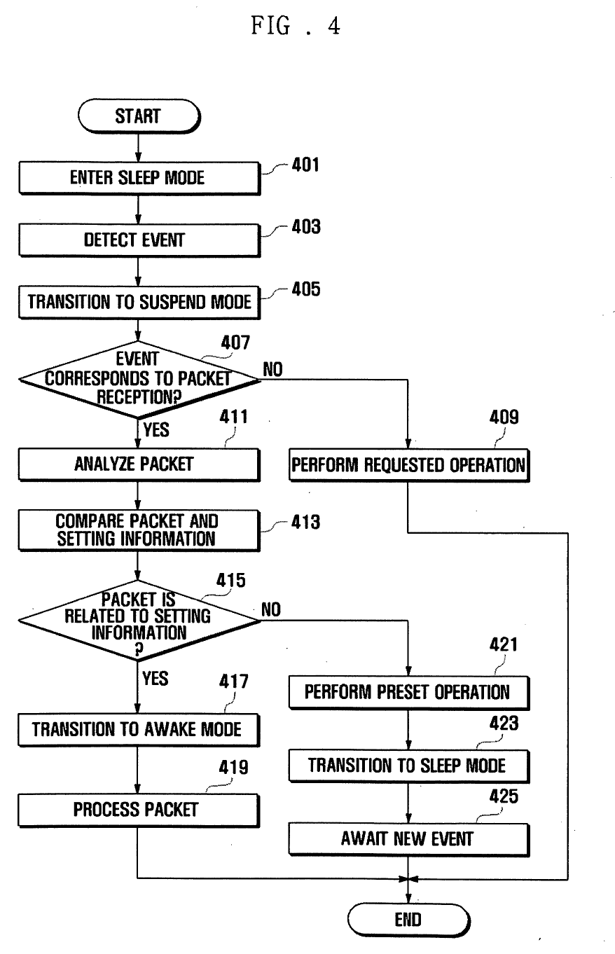

FIG. 4 is a flowchart illustrating a mode control method for a portable terminal according to an exemplary embodiment of the present invention.

Referring to FIG. 4, the portable terminal awaits an event in the sleep mode in step 401. When an event occurs during the sleep mode in step 403, the control unit of the portable terminal controls a transition from the sleep mode into the suspend mode in step 405.

In the suspend mode, the control unit determines whether the event corresponds to reception of an incoming packet in step 407. The event may correspond to reception of an incoming packet, to transmission of an outgoing packet associated with a user request, or to activation of a preset alarm.

If the event does not correspond to reception of an incoming packet, the control unit performs an operation associated with the event in step 409. For example, the control unit controls a transition into the awake mode, and transmits packets in relation to a user request or generates sounds for notification in relation to a preset alarm.

If the event corresponds to reception of an incoming packet, in the suspend mode, the control unit analyzes the received packet in step 411. Packet analysis is described above with reference to FIG. 2.

The control unit compares the packet analysis result with the setting information in step 413, and determines whether the received packet is related to the list of IP-based services to receive in step 415.

If the received packet is related to the list of IP-based services to receive, the control unit controls a transition from the suspend mode into the awake mode in step 417, and performs an operation associated with the received packet in step 419. For example, if the received packet is related to a VoIP service, the control unit processes the received packet according to the VoIP service. If the received packet is related to an HTTP service, the control unit processes the received packet according to the HTTP service.

If the received packet is not related to the list of IP-based services to receive, the control unit performs a preset operation in step 421. For example, the control unit may temporarily store the received packet and notifies the user at a later time after transitioning to the awake mode.

Thereafter, the control unit controls a transition from the suspend mode into the sleep mode in step 423, and awaits a new event in step 425.

While the present invention has been described with reference to certain exemplary embodiments thereof, it will be understood by those skilled in the art that various changes in form and details may be made therein without departing from the spirit and scope of the invention as defined in the appended claims and their equivalents.

What is claimed is:

1. A mode control method for a portable terminal, the method comprising:
analyzing, upon reception of a packet during a sleep mode, the received packet;
determining whether the received packet corresponds to service setting information; and
transitioning, when the received packet corresponds to the service setting information, into an awake mode.

2. The method of claim 1, wherein the analyzing of the received packet comprises:
transitioning, upon reception of the packet during the sleep mode, from the sleep mode into the suspend mode; and
identifying a protocol associated with the received packet in the suspend mode.

3. The method of claim 2, wherein the identifying of the protocol associated with the received packet comprises comparing the protocol associated with the received packet with the service setting information in the suspend mode.

4. The method of claim 3, further comprising:
transitioning, when the protocol associated with the received packet corresponds to the service setting information, from the suspend mode into the awake mode; and
transitioning, when the protocol associated with the received packet does not correspond to the service setting information, from the suspend mode into the sleep mode.

5. The method of claim 1, wherein the service setting information comprises a list of IP-based services classified by protocol.

6. A mode control method for a portable terminal capable of Internet access, the method comprising:
analyzing, when an event related to reception of a packet occurs during a sleep mode, the received packet after transitioning into a suspend mode;
determining whether the received packet corresponds to service setting information by comparing information on the received packet with the service setting information;
transitioning, when the received packet corresponds to the service setting information, from the suspend mode into an awake mode; and
transitioning, when the received packet does not correspond to the service setting information, from the suspend mode into the sleep mode.

7. The method of claim 6, wherein the analyzing of the received packet comprises:
transitioning, when an event occurs during the sleep mode, from the sleep mode into the suspend mode;
identifying a type of the event in the suspend mode; and
examining, when the event is related to reception of a packet, the received packet in the suspend mode.

8. The method of claim 7, wherein the examining of the received packet comprises checking the header of the received packet to identify a protocol associated with the packet.

9. The method of claim 8, wherein the determining of whether the received packet corresponds to the service setting information comprises checking whether the protocol associated with the received packet is related to the service setting information.

10. The method of claim 6, wherein the service setting information comprises a list of IP-based services classified by protocol.

11. A portable terminal capable of Internet access, the terminal comprising:
a communication module for establishing a communication channel to a server through an IP network in a preset manner, and for performing communication for IP-based services;
a storage unit for storing one or more applications used for functions related to the terminal, data generated from execution of the applications, and setting information; and
a control unit for controlling a state of the terminal according to a protocol of a received packet in relation to an IP-based service.

12. The terminal of claim 11, wherein the control unit, upon reception of a packet during a sleep mode, controls a transition from the sleep mode into a suspend mode.

13. The terminal of claim 12, wherein the control unit analyzes, in the suspend mode, the received packet and determines whether the received packet corresponds to service setting information.

14. The terminal of claim 13, wherein the control unit controls, when the received packet corresponds to the service setting information, a transition from the suspend mode into an awake mode, and controls, when the received packet does not correspond to the service setting information, a transition from the suspend mode into the sleep mode.

15. The terminal of claim 12, wherein the control unit comprises:
a packet analyzer for checking the type of the packet received in the sleep mode;
an information comparator for comparing the packet type with the setting information; and
a mode switcher for controlling the operation mode of the portable terminal according to a result of the comparison.

16. The terminal of claim 15, wherein the packet analyzer checks the header of a received packet to identify a protocol associated with the packet.

17. The terminal of claim 16, wherein the information comparator examines whether the protocol associated with the received packet is related to the setting information.

18. The terminal of claim 11, wherein the setting information comprises a list of IP-based services classified by protocol.

19. The terminal of claim 11, wherein the one or more applications comprise at least one of an application that determines a type of a received packet during the sleep mode, compares the packet type with the setting information, and controls the mode of the portable terminal according to a result of the comparison.

20. The terminal of claim 11, further comprising an input unit for inputting the setting information by a user of the terminal.
